(19) United States
(12) Patent Application Publication
(10) Pub. No.: US 2017/0011459 A1
(43) Pub. Date: Jan. 12, 2017

(54) System for Processing Options Contracts with Deferred Setting of Strike Price

(71) Applicant: Chicago Mercantile Exchange Inc., Chicago, IL (US)

(72) Inventors: Richard Co, Chicago, IL (US); Thomas Boggs, Evanston, IL (US); Tim McCourt, New York, NY (US); John Kerpel, Chicago, IL (US)

(21) Appl. No.: 14/795,379

(22) Filed: Jul. 9, 2015

(51) Int. Cl. G06Q 40/04

(52) U.S. Cl. CPC G06Q 40/04

(57) ABSTRACT

Systems and methods are described for processing financial instruments are disclosed. An option on a calendar spread index futures contract allows market participants to manage risks associated with the volatility associated with the calendar spread market for index futures. The options contract has a deferred setting of the strike price that is determined based at least in part on an implied financing rate

### FIELD OF THE INVENTION

The present invention relates to systems and methods for processing option contracts and, in particular, to methods and systems that process an options contract that sets a strike price at settlement.

### BACKGROUND

An option contract is an agreement by which a first party has the right, but not the obligation, to enter into a further agreement at a future time. A second party to an option has an obligation to enter that further agreement if the first party exercises its right. Many types of agreements can be the further agreement that is the subject of an option, i.e., serve as an optioned agreement. Some options and their underlying optioned agreements may be “listed” and multilaterally traded through an exchange. Other options and/or their underlying optioned agreements may be “over the counter” (OTC), e.g., subject to bilateral negotiation and execution.

Options may be a popular investment vehicle due to a strictly limited associated risk, at least for an options buyer. In general, an options buyer may pay a cost of the option, known as the premium, upfront and in cash. Once paid, that premium represents the maximum possible loss to which the option buyer may be exposed. In many cases, options may be combined in different ways. For example, combinations of options may allow for different types of speculation and/or hedging.

A futures contract is a contractual agreement, generally made through a futures exchange, to buy or sell a particular commodity or financial instrument at a pre-determined price in the future. Futures contracts generally detail the quality and quantity of the underlying asset and they are standardized to facilitate trading on a futures exchange. Some futures contracts may call for physical delivery of the asset, while others are settled in cash.

One example of a futures contract is an index futures. Index futures are used when a market participant is implementing a trading strategy that requires exposure to the underlying stock portfolio. Index futures are typically listed in quarterly cycles. Market participants using index futures to gain exposure to the underlying stock portfolio it represents need to “roll” their position over to the next quarterly expiration of the futures contract every quarter. This is done by trading a calendar spread in the futures, (e.g., buying the deferred month contract and selling the expiring month contract simultaneously at a differential, or vice versa). Calendar spread transactions are conventionally quoted in index point differential between the two contracts. The point differential is determined by multiple factors, the most important and potentially volatile of which is the implied financing rate, as well as the underlying index value. The implied financing rate is the interest rate that the exposure to the stock portfolio financed. This implied financing rate is usually expressed as a mark-up or down from a short term interest rate benchmark, e.g. 3-month LIBOR plus/minus spread. The price differential may be determined at the expiration of the nearby contract to maintain a tight connection of the implied financing rate when the index level wonders up and down in the interim.

### SUMMARY

In various embodiments systems and methods are provided for processing financial instruments. An option on a calendar spread index futures contract allows market participants to manage risks associated with the volatility associated with the calendar spread market for index futures. The strike price of the option contract may be set at expiration and the strike price may be a function of an implied financing rate.

In one embodiment, a clearing house computer system is programmed with computer-executable instructions to determine the strike price. The clearing house computer system may receive an implied financing rate for an options contract and an index level at expiration of the options contract. The clearing house computer system can then determine a strike price for the calendar spread of the index futures at expiration based on an index level at expiration of the calendar spread option and the implied financing rate.

The details of these and other embodiments of the present invention are set forth in the accompanying drawings and the description below. Other features and advantages of the invention will be apparent from the description and drawings.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows an illustrative trading network environment for implementing trading systems and methods according to at least some embodiments.

FIG. 2 shows a system for processing option contracts or other financial instruments in accordance with an embodiment of the invention.

FIG. 3 shows a method for processing financial instruments in accordance with an embodiment of the invention.

### DETAILED DESCRIPTION

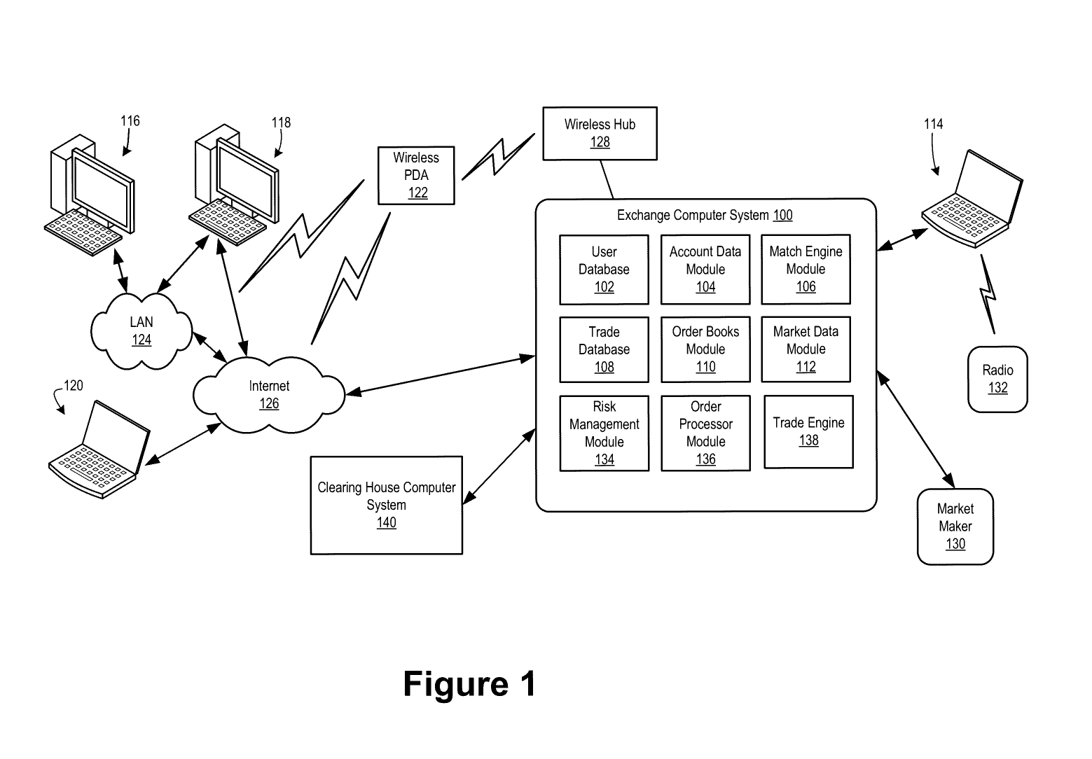

Aspects of at least some embodiments can be implemented with computer systems and computer networks that allow users to communicate trading information. An exemplary trading network environment for implementing trading systems and methods according to at least some embodiments is shown in FIG. 1. The implemented trading systems and methods can include systems and methods, such as are described herein, that facilitate trading and other activities associated with financial products based on currency pairs.

Computer system 100 can be operated by a financial product exchange and configured to perform operations of the exchange for, e.g., trading and otherwise processing various financial products. Financial products of the exchange may include, without limitation, futures contracts, options on futures contracts (“futures contract options”), and other types of derivative contracts. Financial products traded or otherwise processed by the exchange may also include over-the-counter (OTC) products such as OTC forwards, OTC options, etc.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses one or more 64-bit processors. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearing house computer system 140 may be connected to exchange computer system 100 and configured to carry out clearing house operations. Clearing house computer system 140 may receive data from and/or transmit data to trade database 108 and/or other modules of computer system 100 regarding trades of futures contracts, futures contracts options, OTC options and contracts, and other financial products. Clearing house computer system 140 may facilitate the financial product exchange acting as one of the parties to every traded contract or other product. For example, computer system 100 may match an offer by party A to sell a financial product with a bid by party B to purchase a like financial product. Clearing house computer system 140 may then create a financial product between party A and the exchange and an offsetting second financial product between the exchange and party B. As another example, clearing house computer system 140 may maintain margin data with regard to clearing members and/or trading customers. As part of such margin-related operations, clearing house computer system 140 may store and maintain data regarding the values of various contracts and other instruments, determine mark-to-market and final settlement amounts, confirm receipt and/or payment of amounts due from margin accounts, confirm satisfaction of final settlement obligations (physical or cash), etc. As discussed in further detail below, clearing house computer system 140 may determine values for performance bonds associated with trading in products based on various types of currency pairs.

Each of modules 102 through 138 could be separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-140).

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may implement one or more of the well-known LAN topologies and may use a variety of different protocols, such as Ethernet. Computer devices 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet 126. Computer devices 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems (e.g., computer systems of clearing member firms), regulatory systems and fee systems.

The operations of computer devices and systems shown in FIG. 1 may be controlled by computer-executable instructions stored on non-transitory computer-readable media. For example, computer device 116 may include computer-executable instructions for receiving market data from exchange computer system 100 and displaying that information to a user. As another example, clearinghouse module 140 and/or other modules of exchange computer system 100 may include computer-executable instructions for performing operations associated with determining performance bond contributions associated with holdings in products that are based on various types of currency pairs.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

In some respects, an index future is like a leveraged investment. For example, if a market participant wanted $100,000 worth of exposure to an index, the market participant could buy a futures contract for a lessor amount, such as $5,000. In this situation the market participant is effectively financing $95,000 and the implied financing rate is factored into the original futures price of $5,000. The implied financing rate accounts for the time value of the money involved.

As mentioned above, index futures are used when a market participant is implementing a trading strategy that requires exposure to the underlying stock portfolio. Market participants using index futures to gain exposure to the underlying stock portfolio it represents need to “roll” their position over to the next quarterly expiration of the futures contract every quarter. This can be done by trading a calendar spread in the futures, (e.g., buying the deferred month contract and selling the expiring month contract simultaneously, or vice versa). Rolling a position extends the exposure to the underlying investment through the expiration of the deferred contract. The price differential at which the transaction is consummated conveys an implied financing rate at which the exposure is financed through the new expiration.

An implied financing rate for a futures contract based on an underlying physical commodity can be expressed in terms that are meaningful to a market participant. For example, if a futures contract calls for the delivery of physical commodity, the implied financing rate may be expressed in terms of dollars per unit of the physical commodity. The units may be barrels, bushels, gallons, etc. Existing index futures contracts are defined with a dollar multiplier with a price of the futures expressed in index points. In other words, there is no “physical” unit of measurement for the underlying object. The contract merely represents a dollar amount of exposure to the underlying financial asset. Implied financing rates may be a market participant's most important consideration and are not readily apparent from existing price differentials between futures contracts.

The calendar spread market for index futures can be extremely volatile. The price differential between successive expirations of an index futures series is co-determined, amongst other factors, by (1) the level of the index (futures), and (2) the interest rate at which the portfolio is financed for the intervening period between futures expirations. The magnitude of the price differential is larger if the level of the index (futures) is higher, or vice versa. Likewise, the higher the implied financing rate, the higher the price differential. Many market participants are more interested in the implied financing rate than the calendar spread price differential by itself. In accordance with some embodiments of the invention, risks associated with extreme volatility of index futures may be managed with an option on the index futures calendar spread, or an option on the roll. Moreover, the moneyness of the option may be based on the prevailing implied financing rate of the index futures roll market at the time of the options expiration.

The fair value formula that is used to determine the prices for futures contracts may be modified to determine the moneyness of an option on an index futures calendar spread or other options contract. An exemplary version of the index fair value formula is:

F₂−F₁=(F₁+D₁)×R_{1,2}×(#days/360)−ΔD (equation 1)

wherein:
F₁, F₂ futures prices corresponding to expirations 1 and 2 respectively, where expiration 1 is understood to be the nearby expiration and the expiration 2 is the deferred expiration.
D₁, D₂ expected accrual of dividend (in index points) for the underlying stock portfolio of the index before expiration 1 and 2 respectively. Therefore, (D₂−D₁) would denote the dividend accrual in the intervening period between the two expirations. We would denote this dividend amount as ΔD.
R_{1,2} financing rate for the intervening period between expirations 1 and 2
#days number of calendar days between the expirations 1 and 2

Many market participants prefer option contracts with a strike price expressed in terms of of R1,2, or other variables in the other embodiments. Express a strike price of an option in terms of R1,2 provides meaningful information to market participants.

If, at the time of the roll options expiration, the expiration of the nearby index futures is close at hand, the quantity D₁ can be suppressed without materially changing the value. ΔD can be re-cast as d×F₁×(#days/360), where d is the dividend yield per annum instead of the dividend points. Equation 1 can therefore be rewritten as follows:

F₂−F₁=F₁×(R_{1,2}−d)×(#days/360) (equation 2)

From equation 2, an exercise price differential can be determined. On the day of options expiration, an option with a strike specification of s shall be used to determine the strike price as follows:

Exercise Price Differential (EPD)=F×s×(#days/360) (equation 3)

where F is the daily settlement price of the nearby index futures, and #days is the number of calendar days in the intervening period between the expiration of nearby and deferred month index futures.

The exercise price differential (EPD) may be rounded to the nearest futures calendar spread tick increments.

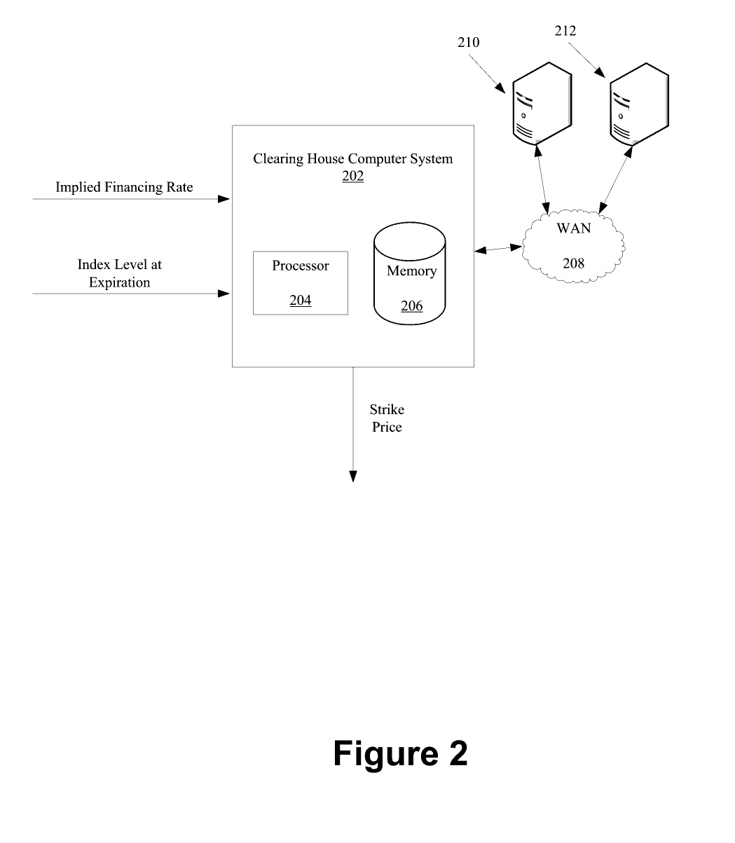

FIG. 2 shows a system for processing option contracts or other financial instruments in accordance with an embodiment of the invention. A clearing house computer system 202 may be similar to clearing house computer system 140 (shown in FIG. 1). Clearing house computer system 202 may include a processor 204 that controls the operation of clearing house computer system 202. A memory 206 may be included to store financial instrument data, computer-executable instructions and/or other data. In one embodiment, memory 206 includes computer-executable instructions that are executed by processor 204 to implement aspects of the invention.

Clearing house computer system 202 may be used to calculate a strike price of an option on a calendar spread futures contract using one or more of the methods described above. Clearing house computer system 202 may receive an implied financing rate as well as an index level at expiration. The implied financing rate and the index level at expiration may be received from an exchange computer system, a market participant computer device or one or more other sources. Clearing house computer system 202 may also be connected to one or more servers or other sources of data, such as servers 210 and 212, via a wide area network 208, such as the Internet 126. Servers 210 and 212 may provide interest rate, market data or any other data that may be used by clearing house computer system 202 to calculate a strike price.

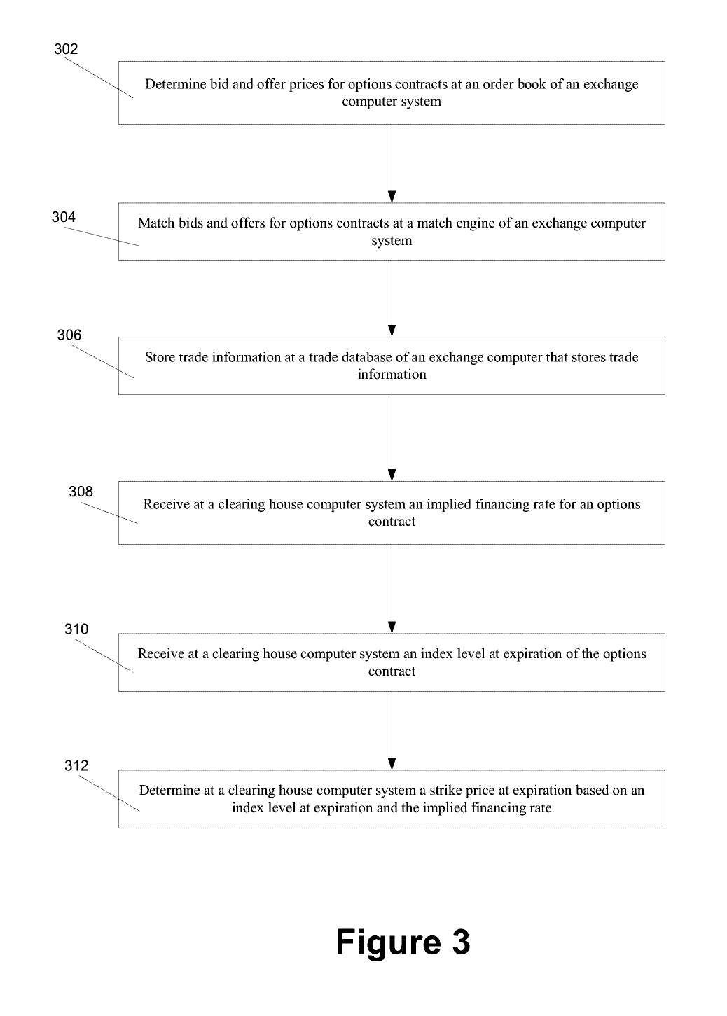

FIG. 3 shows a method for processing financial instruments in accordance with an embodiment of the invention. The steps shown in FIG. 3 may be performed by an exchange computer system, a clearing house computer system or one or more other computer device. First, in step 302 bid and offer prices for options contracts are determined. Step 302 may be performed at an order book of an exchange computer system. In step 302 bids and offers for options contracts are matched. Step 302 may be performed at a match engine of an exchange computer system. Trade information is stored in step 306. The trade information may be stored in a trade database of an exchange computer that stores trade information.

In step 308 a clearing house computer system receives an implied financing rate for an options contract. The implied financing rate may be received from a market participant computer device or another computer device. In step 310 an index level may be received at a clearing house computer system. The index level may be a level that exists at expiration of an options contract. The index level may be for the S&P 500, Russell 2000, the DJ Wilshire 5000, the MSCI EAFE, the Barclays Capital Aggregate Bond Index or any other index that is based on a portfolio of financial instruments.

Finally, in step 310 a clearing house computer system determines a strike price at expiration based on an index level at expiration and the implied financing rate. Step 310 may be performed with one or more of the methods described above. In alternative embodiments, step 310 may be performed with an exchange computer device or one or more other computer devices.

Alternative embodiments of the invention may be used to set a strike price based on various combinations of process, index levels and pre specified variables. In some embodiments a strike price of an option may be set with the following generalized formula:

X=f(p1, p2, p3, . . . , y1, y2, y3, y4 . . . ) (equation 4)
Where
p1, p2, p3, . . . are the price of underlying instrument(s),
y1, y2, y3, y4, . . . are predetermined and pre-specified variables observed and/or measured by a computer device.

The total number of prices may depend on a specific embodiment. In one embodiment, p1 and p2 could be the price of index futures with two different expiration dates. An exemplary y1 value is an interest rate benchmark, such as the 3-month USD LIBOR interest rate. An example y2 value is an expected dividend points of the index for the forward looking period.

The systems and methods described above provided for the efficient processing of financial instruments. Without the systems and methods described above, market participants would have to substitute with a series of trades in the calendar spread throughout the entire life of the options to simulate the existence of such an option. In the parlance of finance and options trading, it is known as delta trading. The series of transactions consumes processing power and bandwidth. The consumption of processing power and bandwidth reduces performance of the computer systems involved. For example, an exchange computer system and a clearing house computer system will not perform functions as quickly if they are processing more orders or performing more calculations. The consumption of bandwidth by increased numbers of orders can limit the performance of computer devices and systems and networks that connect the devices and systems. Further, the delta trading of calendar spread options is only an approximation of the option as the cost of execution as well as the imperfection in execution (i.e. traded price different from the intended price) would reduce the effectiveness of the exercise.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims.

What is claimed is:

1. A system comprising:
an exchange computer system that includes:
an order book that determines bid and offer prices for options contracts;
a match engine that matches bids and offers for options contracts;
a trade database that stores trade information;
a clearing house computer system connected to the exchange computer system and that includes
a processor;
a computer-readable medium containing computer-executable instructions that when executed by the processor cause the clearing house computer system to:
(a) receive an implied financing rate for an options contract;
(b) receive an index level at expiration of the options contract; and
(c) determine a strike price at expiration based on an index level at expiration and the implied financing rate.

2. The system of claim 1, wherein the option contract comprises an option on a calendar spread financial instrument.

3. The system of claim 2, wherein the option contract comprises an option on a calendar spread futures contract.

4. The system of claim 3, wherein (c) comprises determining a strike price of an option on an index futures calendar spread using:
EPD=F*s*(#days/360)
Wherein:
EPD=Exercise Price Differential;
F is a settlement price of a futures contract having a nearby expiration;
S is the implied financing rate; and
# days is the number of calendar days in a period between the expiration of the between the futures contract having a nearby expiration and the futures contract having the deferred expiration.

5. The system of claim 3, wherein the option contract comprises an option on a calendar spread index futures contract.

6. The system of claim 1, wherein the computer-readable medium further contains computer-executable instructions that when executed by the processor cause the clearing house computer system to:
(d) auto exercise options.

7. The system of claim 1, wherein the implied financing rate is based on an interest rate benchmark.

8. The system of claim 1, wherein (c) comprises determining a strike price that is a function of prices of underlying financial instruments and the implied financing rate.

9. The system of claim 8, wherein the strike price is a function process of underlying financial instruments, the implied financing rate and at least one other predetermined variable.

10. The system of claim 9, wherein the at least one other predetermined variable comprises an expected dividend value.

11. The system of claim 8, wherein (c) comprises determining a strike price of an option on an index futures calendar spread.

12. A method comprising:
(a) determining bid and offer prices for options contracts at an order book of an exchange computer system;
(b) matching bids and offers for options contracts at a match engine of an exchange computer system;
(c) storing trade information at a trade database of an exchange computer that stores trade information;
(d) receiving at a clearing house computer system an implied financing rate for an options contract;
(e) receiving at a clearing house computer system an index level at expiration of the options contract; and
(f) determine at a clearing house computer system a strike price at expiration based on an index level at expiration and the implied financing rate;
wherein, the clearing house computer system is connected to the exchange computer system.

13. The method of claim 12, wherein the option contract comprises an option on a calendar spread financial instrument.

14. The method of claim 13, wherein the option contract comprises an option on a calendar spread futures contract.

15. The method of claim 14, wherein (f) comprises determining a strike price of an option on an index futures calendar spread using:
EPD=F*s*(#days/360)
Wherein:
EPD=Exercise Price Differential;
F is a settlement price of a futures contract having a nearby expiration;
S is the implied financing rate; and
# days is the number of calendar days in a period between the expiration of the between the futures contract having a nearby expiration and the futures contract having the deferred expiration.

16. The method of claim 12, wherein the implied financing rate is based on an interest rate benchmark.

17. The method of claim 12, wherein (f) comprises determining a strike price that is a function of prices of underlying financial instruments and the implied financing rate.

18. The method of claim 17, wherein the strike price is a function process of underlying financial instruments, the implied financing rate and at least one other predetermined variable.

19. The method of claim 18, wherein the at least one other predetermined variable comprises an expected dividend value.

20. The method of claim 12, wherein (f) comprises determining a strike price of an option on an index futures calendar spread.
